(19) United States
(12) Patent Application Publication
(10) Pub. No.: US 2006/0233957 A1
(43) Pub. Date: Oct. 19, 2006

(54) Method for non-woven flame blocking fabric

(76) Inventor: Loren M. Collins, Mount Pleasant, SC (US)

Correspondence Address: W. PETE REID;ATTORNEY AT LAW, LLC, PO BOX 13555, CHARLESTON, SC, 29422-3555, US

(21) Appl. No.: 11/386,970

(22) Filed: Mar. 22, 2006

Related U.S. Application Data
(63) Continuation of application No. 10/448,601, filed on May 30, 2003, now abandoned.

(51) Int. Cl. B05D 3/12; B05D 3/02

(52) U.S. Cl. 427/365; 427/393.3

(57) ABSTRACT

A non-woven flame blocking fabric and method utilizes a fibrous blend of a concentration of cellulosic natural fibers (A) and a concentration of synthetic fibers (B) to which a flame retardant composition (C) is applied. The concentrations of fibers are blended and treated to form a flame retardant fiber blend capable of forming a non-woven flame blocking fabric that upon exposure to flame forms a reinforced char barrier (D) that prevents the flame from igniting any flammable substrate. The reinforced char barrier (D) includes the carbonized cellulosic natural fibers and melted synthetic fibers. A concentration of binder fibers or powders (E) may alternatively supplement the fiber blend to produce a low profile flame blocker fabric upon activation and calendaring. The fabric preferably has a low profile as a result of compaction and bonding, but the fabric may be provided as a high-loft web.

### CROSS-RELATED APPLICATION DATA

This is a continuation-in-part application of application Ser. No. 10/448,602, filed May 30, 2003.

### BACKGROUND

This invention relates to a non-woven flame blocker fabric that will not ignite or burn upon exposure to open flame and the resultant heat but instead forms a reinforced char barrier that prevents a flame from igniting any flammable substrate.

Non-woven fibers and fabrics possessing flame-retardant properties have been manufactured and sold for at least twenty-five years. These prior flame-retardant fabrics, while resistant to flame, are lacking in structural integrity, however, having virtually zero puncture, tear, cross direction, and machine direction strength prior to exposure to flame. Of greater concern, the flame-retardant materials produced in these previous methods are virtually reduced to dust when exposed to an open flame, having no tensile strength upon charring. These fabrics were limited in their end uses, and flame retardant materials produced by this method were used primarily in incontinent pad sheets and medical or emergency services clothing materials. Thus, fabrics such as disclosed in U.S. Pat. Nos. 6,132,476, 5,609,950, 5,766,746, and 4,151,322, are incapable of forming a reinforced char barrier which prevents a flame from igniting any flammable substrate.

The formation of a char barrier was a focus of the disclosure U.S. Pat. No. 5,645,926 Horrocks, et al., disclosing a flexible fire-resistant material comprising a mixture of organic intumescent filler and organic and/or inorganic fibers adapted to produce a char barrier upon exposure to heat that retains structural integrity. A disadvantage of Horrocks is its requirement for the use of an intumescent filler material tending to result in a thicker product. Specifically, intumescent materials swell and char when exposed to flame, making the application of intumescent fillers in composite structures for protecting substrate materials disadvantageous. Furthermore, Horrocks did not attempt to provide reinforcement for imparting structural integrity to the char barrier.

### SUMMARY

An important object of the invention is to provide a non-woven flame blocker fabric which will not ignite or burn upon exposure to open flame and the resultant heat but forms a reinforced char barrier which prevents a flame from igniting any flammable substrate.

Still another important object of the invention is a non-woven flame blocker fabric which will not ignite when exposed to flame and is self-extinguishing.

Another important object of the invention is a non-woven flame blocker fabric capable of forming a reinforced char barrier with substantial tensile, tear, and puncture strength.

Yet another important object of the invention a non-woven flame blocker fabric capable of forming a reinforced char barrier which does not dust or disintegrate when stressed.

Another important object of the invention is a non-woven flame blocker fabric formed from a flame retardant fiber blend.

Yet another important object of the invention is a flame retardant fiber blend comprising a blend of cellulosic natural fibers, synthetic fibers, and binder fibers or powders.

Accordingly, it has been found that by utilizing a bonded non-woven fibrous web consisting essentially of a concentration of cellulosic natural fibers capable of forming a char barrier upon exposure to flame, blended with a concentration of synthetic fibers capable of substantially melting upon exposure to flame, and treated with a flame retardant, produces a non-woven flame blocking fabric capable of forming a reinforced char barrier upon exposure to flame consisting of the charred concentrations of cellulosic natural fibers structurally reinforced by the melted concentrations of synthetic fibers, wherein the reinforced char barrier prevents the flame from igniting any flammable substrate.

A concentration of binder fibers or powders may supplement the fiber blend to produce, upon binder activation and calendaring, a low profile flame blocker fabric capable of forming a reinforced char barrier that prevents a flame from igniting any flammable substrate.

### BRIEF DESCRIPTION OF THE DRAWINGS

The construction designed to carry out the invention will hereinafter be described, together with the features thereof.

The invention will be more readily understood from a reading of the following specification and by reference to the accompanying drawings forming a part thereof, wherein an example of the invention is shown and wherein:

FIG. 1. is a sectional elevation illustrating a cross-section of a non-woven fibrous web constructed in accordance with the invention;

FIG. 2. is a schematic elevation illustrating a method of bonding and compressing and a non-woven fibrous web constructed in accordance with the invention utilizing needle-punching and calendar rolls;

FIG. 3. is a schematic side elevation illustrating a method of heat activating compressing and heat bonding a non-woven fibrous web containing a concentration of binder fibers or powders to form a low-profile non-woven flame blocker fabric constructed in accordance with the invention;

FIG. 4. is a schematic elevation illustrating the use of adjustable transversely positioned heated and cooled calendar rolls for forming a variety of non-woven fabric profiles constructed in accordance with the invention;

FIG. 5. is a schematic elevation illustrating the processing of a non-woven fibrous web constructed in accordance with the invention utilizing an apparatus for imparting texture to the non-woven fibrous web;

FIG. 6. is a schematic elevation illustrating the processing of a non-woven fibrous web constructed in accordance with the invention utilizing foam applicators for treating the non-woven fibrous web with a flame retardant;

FIG. 7. is a schematic elevation illustrating the processing of a non-woven fibrous web constructed in accordance with the invention utilizing a dip and squeeze tank for treating the non-woven fibrous web with a flame retardant;

FIG. 8. is a schematic illustration of the processing of a fibrous web constructed in accordance with the present invention utilizing spray applicators for treating the non-woven fibrous web with a flame retardant;

FIG. 9. is a schematic view illustrating the processing of a carded non-woven air laid fibrous web constructed in accordance with the invention utilizing a movable apron and the optional use of multiple calendar rolls for compression of the web;

FIG. 10. is a schematic view similar FIG. 9 illustrating the processing of a carded non-woven air laid fibrous web constructed in accordance with the invention including the step of supplementing the web with a concentration of binder fibers or powders utilizing a movable apron and the optional use of multiple calendar rolls for compression of the web;

FIG. 11. is a flow chart diagram illustrating the process of forming a non-woven flame blocker fabric constructed in accordance with the invention;

FIG. 12. is a block diagram illustrating the processing stages for manufacturing a non-woven flame blocking fabric in accordance with the invention;

FIG. 13. is a schematic view illustrating the processing of a non-woven air doffed fibrous web in accordance with the invention utilizing a carding machine and a moveable apron for forming an air laid non-woven fibrous web;

FIG. 14. is a schematic elevation similar to FIG. 13 illustrating the processing of a non-woven air doffed fibrous web in accordance with the invention utilizing a carding machine and a moveable apron for forming a cross-lapped non-woven fibrous web;

FIG. 15. is a schematic elevation illustrating a calendared non-woven air doffed fibrous web as may be constructed as illustrated in FIGS. 13 and 14 utilizing a movable apron for construction of a high-loft web, and optionally, heated calendar rolls for construction of a low profile web;

FIG. 16. is a schematic elevation illustrating the processing of a non-woven mechanically doffed fibrous web constructed in accordance with the invention utilizing a carded web carried by textured rolls for the application of water or other fluid for the formation of a non-woven web bonding by hydro-entanglement;

FIG. 17. is a cross sectional view illustrating an article of furniture in the form of a mattress having a composite structure including an exterior ticking layer encapsulating a foam cushion layer, including the non-woven flame blocking fabric constructed in accordance with the invention inserted between the ticking and foam wherein upon exposure to flame the flame blocker fabric will not ignite or burn upon but instead forms a reinforced char barrier which prevents the flame from igniting the flammable foam substrate; and

FIG. 18 is a cross sectional view illustrating an article of furniture in the form of upholstered seating having a composite structure including an exterior ticking layer encapsulating a foam cushion layer, including the non-woven flame blocking fabric constructed in accordance with the invention inserted between the ticking and foam wherein upon exposure to flame the flame blocker fabric will not ignite or burn upon but instead forms a reinforced char barrier which prevents the flame from igniting the flammable foam substrate.

FIG. 19. is an idealized view illustrating a non-woven fibrous web constructed in accordance with the invention including a web portion exposed to open flame having created a reinforced char barrier capable of preventing the flame from igniting any flammable substrate with minimal change in the size of the web.

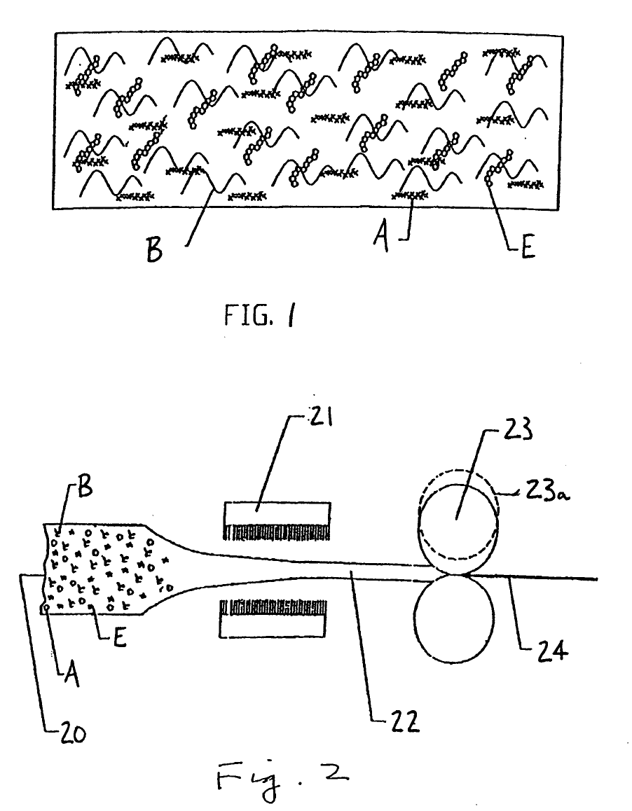

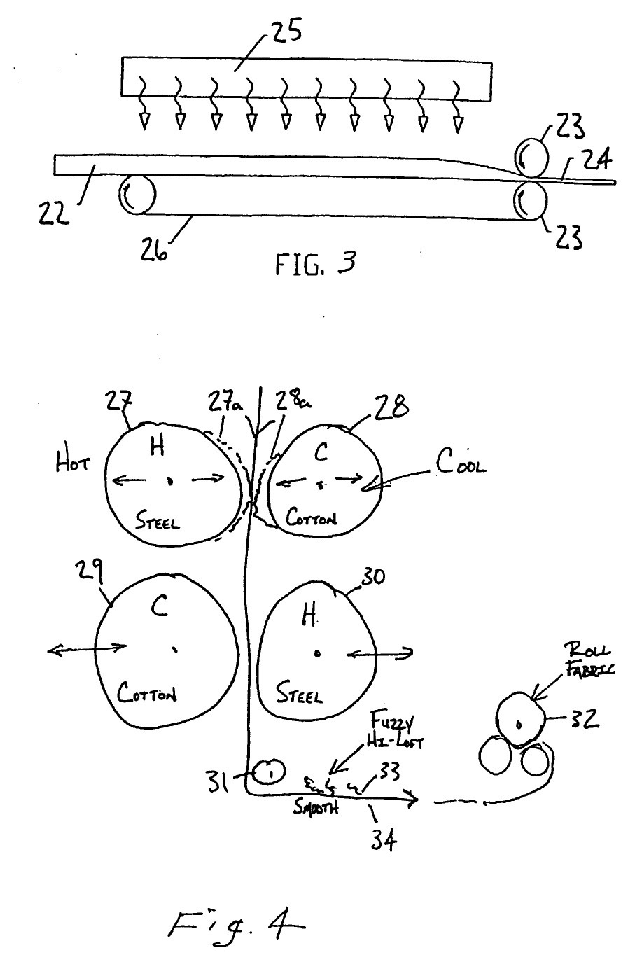

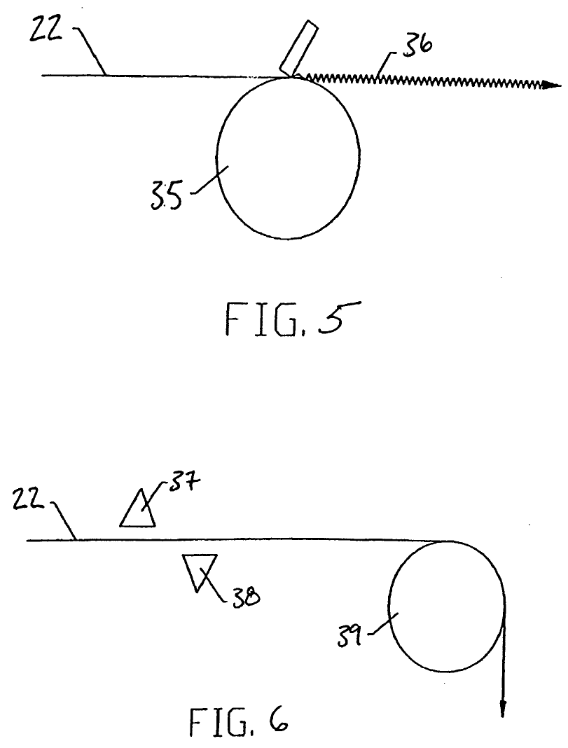

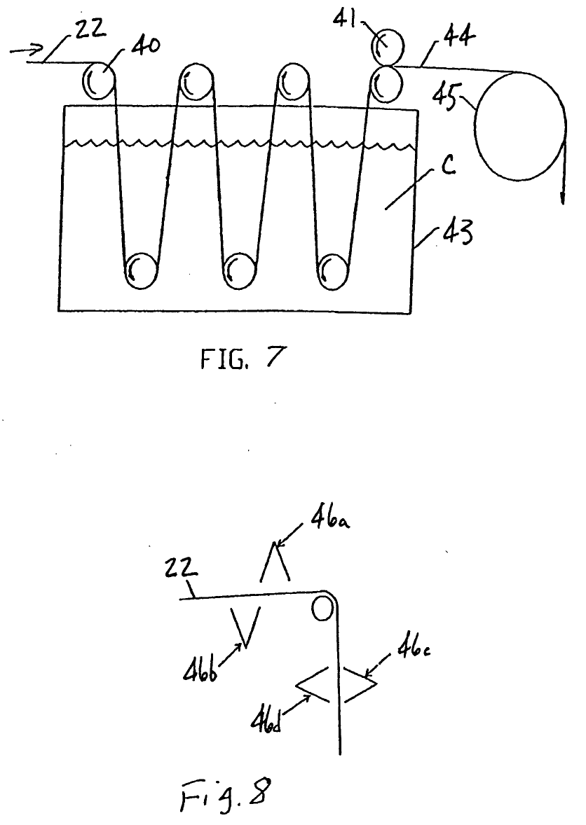

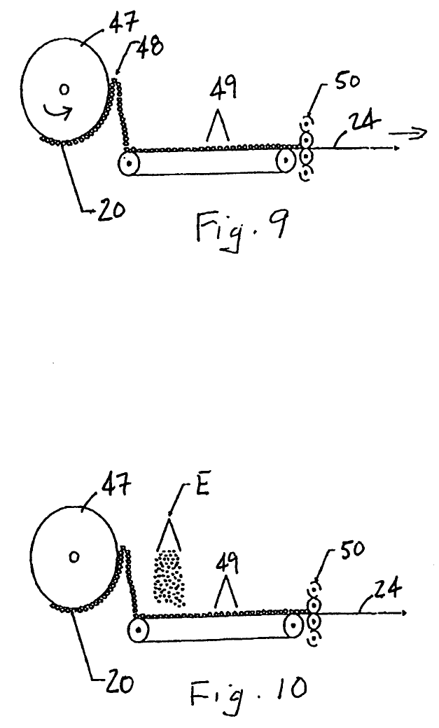

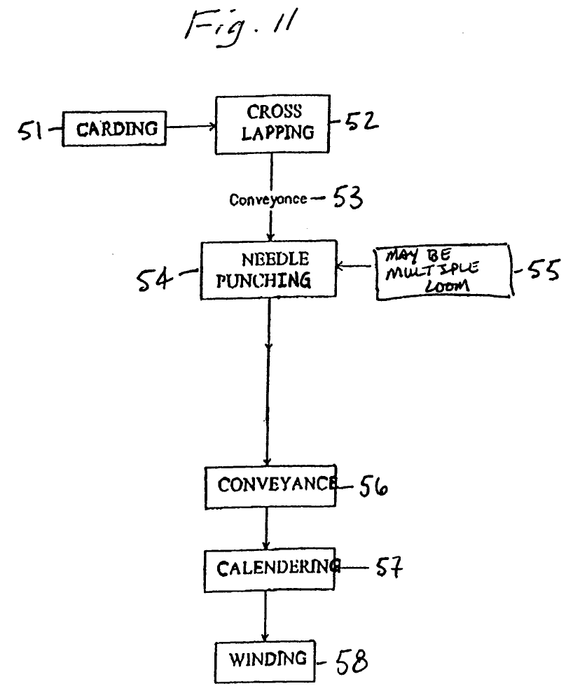

### DETAILED DESCRIPTION

The drawings illustrate a non-woven flame blocking fabric that will not ignite or burn upon exposure to open flame and the resultant heat but forms a reinforced char barrier which prevents a flame from igniting any flammable substrate. In a preferred embodiment the invention comprises a concentration of cellulosic natural fibers A selected from the group consisting of cotton, flax, hemp, kenauf, and rayon, a concentration of synthetic fibers B selected from the group consisting of polyester, nylon, and polyethylene, and a non-expansive flame retardant C. The concentrations of fibers are blended and treated to form a flame retardant fiber blend capable of forming a non-woven flame blocking fabric which forms a reinforced char barrier D upon exposure to flame. A concentration of binder fibers or powders E may alternatively supplement the fiber blend to produce a low profile flame blocker fabric upon activation and calendaring.

The concentration of cellulosic natural fibers A is preferably selected from a group consisting essentially of cotton, flax, hemp, kenauf, and rayon. This natural fiber concentration must be cellulosic or comprise an natural blend having a substantial cellulosic component. The use of cellulosic natural fibers is important to ensure that a proper char barrier is produced upon exposure to flame. Any denier or staple length of cellulosic natural fiber may be used.

The concentration of synthetic fibers B is preferably selected from the group consisting essentially of polyester, nylon, and polyethylene. The synthetic fiber concentration may comprise a single fiber type or a blend of different synthetic fibers, and any denier or staple length of synthetic fiber may be used.

In a preferred embodiment the individual fiber concentrations of cellulosic natural fibers A, synthetic fibers B, and or binder fibers or powders E are intimately blended to form an unbonded fiber blend. Prior to blending the individual fiber concentrations may be treated with a flame retardant C, the flame retardant may be applied to the unbonded intimately blended fiber blend, and or the flame retardant may be applied to a bonded non-woven fibrous web. Of preferred use is the flame retardant Glo-Tard BFA manufactured by Glo-Tex International of Spartanburg, S.C. Other flame retardants, however, may be used. The flame retardant is preferably applied via spraying, foaming, and or dipping and squeezing the web or individual fiber concentrations to be treated. It is contemplated that more than one method of imparting the flame retardant may be used.

The concentration of binder fibers or powders E may supplement the fiber blend and is preferably selected from the group consisting of polyester binder fiber, nylon binder fiber, polypropylene fibers and or cryogenically ground low melt binder powders. This binder fiber or powder concentration may comprise a single binder fiber or powder type or a blend of different binder fibers and or powders. Any denier or staple length of binder fiber may be used.

The binder fibers or binder powders E, preferably supplement the fiber blend when a low profile flame blocker fabric in accordance with the invention is desired. The addition of a concentration of binder fiber or powder to the fiber blend serves two purposes. In a preferred embodiment, the binder fiber or powder has the ability to activate or become “tacky” at a tack melting point of approximately 240.degree. F. Secondly, upon becoming “tacky”, the binder fiber or powder acts as an adhesive that provides a strong bond between the synthetic and cellulosic natural fibers.

The individual fiber concentrations by weight comprising the unbonded fiber blend are important to the flame blocking properties of the non-woven flame blocking fabric produced from the fiber blend. It is believed that the unbonded fiber blend may comprise up to about 95% by weight cellulosic natural fiber A, up to about 80% by weight synthetic fibers B, and or up to about 30% by weight binder fiber or binder powder E. In a preferred embodiment the unbonded fiber blend comprises about 40-60% by weight cellulosic natural fiber A, about 30-50% synthetic fiber B, and or up to about 15% binder fiber or powder E. It has been found a fiber blend having a concentration of synthetic fibers less than 20% by weight produces a flame blocker fabric exhibiting marginal ability upon exposure to flame to form a reinforced char barrier capable of preventing a flame from igniting any flammable substrate. Although the above concentrations ranges are primarily established from practical considerations, empirical evidence may establish other ranges or fiber concentrations that yield an adequate reinforced char barrier capable of preventing a flame from igniting any flammable substrate.

In accordance with the claims, the flame retardant fiber blend may be formed into a non-woven flame blocking fabric. A preferred method for manufacturing a non-woven flame blocking fabric from the flame retardant fiber blend comprises the following steps: blending a concentration of cellulosic natural fibers and synthetic fibers to form an unbonded fiber blend. The concentrations of cellulosic natural fibers and concentrations of synthetic fibers are bonded to form a bonded fiber blend, and a flame retardant is applied. Binder fibers or powders may supplement the fiber blend for rendering the fabric calenderable into a low-profile flame blocker fabric.

It is important the non-woven flame blocking fabric be constructed utilizing a blend of cellulosic natural fibers A, synthetic fibers B, a flame retardant C, and or binder fibers or powders E. It has been found a non-woven flame blocker fabric produced from a flame retarded fiber blend consisting only of a concentration of synthetic fiber (or blend of different synthetic fibers) and a concentration binder fiber melts upon exposure to flame into a non-continuous globular mass incapable of preventing the flame from igniting a flammable substrate. On the other hand, It has been found that a non-woven flame blocker fabric produced from a flame retarded fiber blend consisting only of a concentration cellulosic natural fiber, with no synthetic fiber or binder component, upon exposure to flame would char and temporarily block the flame, however, the charred fibers exhibit no physical strength and practically dust and disintegrate when stressed.

An important object of the invention is to provide a non-woven flame blocking fabric that will not ignite or burn upon exposure to open flame and the resultant heat but forms a reinforced char barrier D that prevents a flame from igniting any flammable substrate. The non-woven flame blocking fabric preferably creates a reinforced char barrier D upon exposure to an open flame or resultant heat temperatures in excess of 400.degree. C.

Upon exposure to flame, the concentration of cellulosic natural fibers char and (approximately simultaneously) the concentration of synthetic fibers substantially melt, creating in essence, a hot liquid including synthetic fibers containing charred cellulosic fibers. The synthetic fiber liquid reinforces the carbonized cellulosic fibers to form a reinforced char barrier D with significantly greater tensile strength and flexibility. Although the synthetic fibers are in a molten state, the charred cellulosic fibers in contact with the synthetic slurry prevent the slurry from flowing through the char or creating a gap in the char for a flame to reach a flammable substrate.

The non-woven flame blocker fabric is, upon exposure to flame, transformed from a fibrous structure containing distinct and separate fibers (comprising cellulosic natural fibers A, synthetic fibers B, and or binder fibers or powders E) into a reinforced char barrier D which no longer contains separate and distinct fibers but is thought to be a homogenous structure of cellulosic natural char held and bonded together with molten synthetic material, which upon melting into a liquid flows into and encapsulates the charred cellulosic natural components. This charred cellulosic natural component is reinforced by the synthetic component, imparting substantial tensile, tear, and puncture strength, which imparts improved flexibility to the charred flame blocker fabric, and prevents dusting or disintegration of the structure when stressed.

This is not to say the non-woven flame blocker fabric constructed in accordance with the invention, when in a reinforced char barrier state, will have the puncture and tensile strength to withstand a major impact. The reinforced char barrier will, however, have substantial tensile, tear, and puncture strength, which imparts greater flexibility to the flame blocker fabric, and prevents dusting or disintegration of the structure when moderately stressed.

The char barrier formed by the non-woven flame blocker fabric constructed in accordance with the invention does not swell or expand upon exposure to open flame or the resultant heat.

The flame retardant fiber blend may be formed into a non-woven flame blocking fabric of two distinct types: a high-loft non-woven fabric and a calendared low profile fabric. Each of these fabrics, upon exposure to flame, forms a reinforced char barrier which prevents the flame from igniting any flammable substrate. A difference between the fabrics is in the method of bonding, the presence and activation of a concentration of binder fibers or powders E and the process of calendaring.

The high-loft non-woven flame blocking fabric constructed in accordance with the invention gets its name by comparing its thick or high caliber state to that of a low profile condensed sheet. As a general rule, all high-loft non-woven fabric is produced by first carding the fiber blend. The fiber blend can be removed from the carding machine and formed into a non-woven fibrous web via air doffing or mechanical doffing.

Air doffing involves the use of a fan or blower to remove the fibers from the carding machine where they are typically suctioned on to a moveable apron. The result is an air laid isotropic web or non-woven.

Mechanical doffing involves mechanically removing the fibers from the carding machine typically utilizing an apparatus having opposing card teeth to physically contact and remove the fibers from the carding machine only to deposit the fibers onto a moveable apron. The result is a carded high-loft non-woven fabric that is generally stronger in the cross direction than in the machine direction.

The calendared low profile non-woven flame blocking fabric constructed in accordance with the invention differs in construction from the high-loft as to: the method of bonding, the supplementation of a concentration of binder fiber or powder E to the fiber blend, and the process of calendaring.

In a preferred embodiment the low profile non-woven flame blocking fabric is mechanically bonded and compacted via needle-punching. The supplementation of the fiber blend with a concentration of binder fiber or powder is directly related to the calendaring process. The binder fiber or powder first activates or becomes “tacky” at approximately 240.degree. F. Secondly, upon becoming “tacky”, the binder fiber or powder acts as an adhesive which provides a strong bond between the synthetic and cellulosic natural fibers. This is important to producing a low profile fabric. As the non-woven fibrous web is processed the binder fiber or powder may be activated in several ways. The binder may be activated by passing the web through a heat source such as an oven, or the binder can be activated utilizing heated calendar rolls. Whatever the method employed, to produce the low profile fabric the web must be compressed as by being calendared. Thus using a heat source requires the separate steps of activation and calendaring, while a heated calendar roll completes the activation and compression in a unitary step.

The flame blocking fabric constructed in accordance with the invention has broad applications within a variety of fields, especially within the fields of bedding, furniture, upholstery, blankets, comforters, and protective clothing. The examples set forth below are not exhaustive, for other fields of use or specific applications not set forth below may benefit from the present invention's reinforced char barrier which prevents a flame from igniting any flammable substrate.

In a preferred embodiment the flame blocking fabric constructed in accordance with the invention is employed with in a mattress and foundation assembly having a composite structure including an exterior ticking layer encapsulating a foam cushion layer, including the non-woven flame blocking fabric constructed in accordance with the invention inserted between the ticking and foam.

It is well known that the flammability of mattress foam is akin to jet fuel. The flame blocking fabric when inserted between the ticking and foam on a mattress, and subjected to an open flame, does not ignite or burn, but instead forms a reinforced char barrier which prevents the flame from igniting the flammable foam substrate.

### EXAMPLE 1

A mattress and foundation assembly having a composite structure including an exterior ticking layer encapsulating a foam cushion layer, including the non-woven flame blocking fabric constructed in accordance with the invention inserted between the ticking and foam was submitted to Omega Point Laboratories of Elmendorf, Tex., for testing in accordance with Technical Bulletin 603, Requirements And Test procedure For Resistance Of A Residential Mattress/Box Springs Set To A Large Open Flame.

This fire test response protocol utilizes a pair of propane burners designed to mimic the heat flux levels and durations imposed on a mattress and foundation by burning bedclothes. The test specimen cannot exceed 150 kW of heat release during the one (1) hour test period and cannot exceed 25 MJ of total heat release in the first ten (10) minutes of the test or the specimen fails the requirements of the test.

The test specimen submitted consisted of a twin size (74.5″.times.38″.times.10″) residential type mattress and foundation. All instrumentation was zeroed, and calibrated prior to testing. The test specimen, after conditioning to 73.degree. F. and 50% relative humidity, was placed underneath the collection hood. The specified pair of propane test burners were placed on the top panel and border as specified in the test protocol. The computer data acquisition system was started. After one minute of ambient data acquisition, the burners were ignited and left to burn for 70 seconds (top) and 50 seconds (border), repectively. After both burners were ceased, the burner apparatus was backed away from the test specimen. The test was allowed to proceed until either all combustion ceased, one hour passed, or the development of a fire of such size as to require suppression for the safety of the facility.

Observations during the test were recorded.

| TIME (min:sec) | OBSERVATION |
|---|---|
| 0:00 | The test was started. |
| 0:02 | The fabric covering the mattress began to melt. |
| 0:08 | The ticking material ignited. |
| 0:25 | Flaming drops began to fall from the specimen. |
| 0:50 | The side (border) burner was turned off. |
| 1:10 | The top test burner was turned off. |
| 2:58 | All flame ceased on the top panel of the mattress. |
| 7:42 | All flame ceased on the specimen. |
| 9:26 | All smoldering of the specimen ceased and the |
| | test was terminated. |

| | |
|---|---|
| Maximum Room Smoke | 0.8 |
| Time to Maximum Smoke (minutes) | 0.9 |
| Weight Loss in 10 Minutes (pounds) | 1.2 |
| Maximum Ceiling Temperature (.degree. F.) | 77.9 |
| Time to Maximum. Ceiling Temperature (minutes) | 8.1 |
| Maximum 4′ Temperature (F.) | 74.9 |
| Time to Maximum 4′ Temperature (minutes) | 7.5 |
| Maximum Room Carbon Monoxide (ppm) | 6124.0 |
| Time to Maximum Room Carbon Monoxide (minutes) | 2.8 |
| Time Room Carbon Monoxide Did Not Exceed | 5 |
| 1000 ppm (minutes) | |
| Maximum Smoke Release Rate (m.sup.2/sec | 0.0 |
| Time to Maximum Smoke Release Rate | 1.2 |
| Total Smoke Release First 10 Minutes (m.sup.2/sec) | 3.2 |
| Maximum Heat Release Rate (kW) | 41.4 |
| Time to Maximum Heat Release Rate (minutes) | 1.3 |
| Time to Heat Release Rate In Excess of 100 kW (minutes) | NE |
| Total Heat Release First 10 Minutes (MJ) | 2.6 |

After cooling the mattress was observed to be damaged as follows: Mattress Ticking 5% consumed/charred; Internal Components 2% consumed; Mattress Barrier: Intact; and Foundation Fabric 10% consumed.

The mattress and foundation assembly having a composite structure including an exterior ticking layer encapsulating a foam cushion layer, including a non-woven flame blocking fabric constructed in accordance with the invention inserted between the ticking and foam Passed the requirements set forth in Technical Bulletin 603, Requirements And Test procedure For Resistance Of A Residential Mattress/Box Springs Set To A Large Open Flame, generating a Maximum Heat release of 41.4 kW and a Total Heat Release in 10 Minutes of 2.6 MJ.

In a preferred embodiment the flame blocking fabric constructed in accordance with the invention is employed within an upholstered seating assembly having a composite structure including an exterior ticking layer encapsulating a foam cushion layer, including the non-woven flame blocking fabric constructed in accordance with the invention inserted between the ticking and foam.

It is well known that furniture foam is similar to mattress foam having a flammability akin to jet fuel. The flame blocking fabric constructed in accordance with the invention when inserted between the ticking and foam on a upholstered seating assembly, and subjected to an open flame, does not ignite or burn, but instead forms a reinforced char barrier which prevents the flame from igniting the flammable foam substrate.

### EXAMPLE 2

Foam slabs in an upholstered seating configuration having a composite structure including an exterior ticking layer encapsulating a foam cushion layer, including the non-woven flame blocking fabric constructed in accordance with the invention inserted between the ticking and foam was submitted to Omega Point Laboratories of Elmendorf, Tex., for testing in accordance with BS 5852:1990 Assessment Of The Ignitability Of Upholstered Seating By Smouldering and Flaming Ignition Sources, SECTION 4, IGNITION SOURCE: CRIB 5. This test is commonly referred to as the “British Crib 5” test. The flame blocker fabric utilized in this test comprised a flax/polyester fibrous blend as constructed in accordance with the invention.

Summary of Test Method: The test method involved attaching the foam slabs to the steel rig as specified in the standard. A wood crib specified as Crib 5 (source 5) in the standard was placed on the sample such that the crib contacted the back and was at least 100 mm from any edge. The felt on the crib was soaked with the specified amount of alcohol and ignited. The crib and specimen were left to burn until failure occurred or the sample extinguished itself. This procedure is followed twice on two separate samples.

Test Criteria: A specimen fails the test if: the composite produces smoke, heat, or glowing 60 minutes after starting the test; the composite displays escslating combustion; the composite smolders or burns until it is essentially consumed; the composite smolders to the extremities of the specimen; the composite chars more than 100 mm in any direction apart from upwards due to smoldering; the composite flames for more than 10 minutes after starting the test; the composite burns to the extremities of the specimen (lower margin, either side or full thickness except the upper margin).

Test Results

| CRITERIA | Test 1 | Test 2 |
|---|---|---|
| Combustion Time >60 Minutes | No | No |
| Escalating Combustion No No | No | No |
| Combustion Until Consumed* No No | No | No |
| Smoldering To Extremities* No No | No | No |
| Char >100 mm Due To Smoldering* No No | No | No |
| Flames after 10 Minutes No No | No | No |
| Flames Reach Extremities Except Upper Margin* | No | No |

*Within the test duration (1 hour from the beginning of the test)

The foam slabs in an upholstered seating configuration having a composite structure including an exterior ticking layer encapsulating a foam cushion layer, including the non-woven flame blocking fabric constructed in accordance with the invention inserted between the ticking and foam passed the criteria set forth in BS 5852:1990 Assessment Of The Ignitability Of Upholstered Seating By Smouldering and Flaming Ignition Sources, SECTION 4, IGNITION SOURCE: CRIB 5.

### EXAMPLE 3

Foam slabs in an upholstered seating configuration having a composite structure including an exterior ticking layer encapsulating a foam cushion layer, including the non-woven flame blocking fabric constructed in accordance with the invention inserted between the ticking and foam was submitted to Omega Point Laboratories of Elmendorf, Tex., for testing in accordance with BS 5852:1990 Assessment Of The Ignitability Of Upholstered Seating By Smouldering and Flaming Ignition Sources, SECTION 4, IGNITION SOURCE: CRIB 5. This test is commonly referred to as the “British Crib 5” test. The flame blocker fabric utilized in this test comprised a rayon/polyester fibrous blend as constructed in accordance with the invention.

Summary of Test Method: The test method involved attaching the foam slabs to the steel rig as specified in the standard. A wood crib specified as Crib 5 (source 5) in the standard was placed on the sample such that the crib contacted the back and was at least 100 mm from any edge. The felt on the crib was soaked with the specified amount of alcohol and ignited. The crib and specimen were left to burn until failure occurred or the sample extinguished itself. This procedure is followed twice on two separate samples.

Test Criteria: A specimen fails the test if: the composite produces smoke, heat, or glowing 60 minutes after starting the test; the composite displays escalating combustion; the composite smolders or burns until it is essentially consumed; the composite smolders to the extremities of the specimen; the composite chars more than 100 mm in any direction apart from upwards due to smoldering; the composite flames for more than 10 minutes after starting the test; the composite burns to the extremities of the specimen (lower margin, either side or full thickness except the upper margin).

Test Results Test Results

| CRITERIA | Test 1 | Test 2 |
|---|---|---|
| Combustion Time >60 Minutes | No | No |
| Escalating Combustion No No | No | No |
| Combustion Until Consumed* No No | No | No |
| Smoldering To Extremities* No No | No | No |
| Char >100 mm Due To Smoldering* No No | No | No |
| Flames after 10 Minutes No No | No | No |
| Flames Reach Extremities Except Upper Margin* | No | No |

*Within the test duration (1 hour from the beginning of the test)

The foam slabs in an upholstered seating configuration having a composite structure including an exterior ticking layer encapsulating a foam cushion layer, including the non-woven flame blocking fabric constructed in accordance with the invention inserted between the ticking and foam passed the criteria set forth in BS 5852:1990 Assessment Of The Ignitability Of Upholstered Seating By Smouldering and Flaming Ignition Sources, SECTION 4, IGNITION SOURCE: CRIB 5.

### EXAMPLE 4

This protocol provides a means of determining the char strength of a nonwoven calendared low profile sample in accordance with the invention after exposure to a flame ignition source under well ventilated conditions.

Summary of Test Method: A 6 inch×6 inch nonwoven test specimen was place between two (2) 8 inch×8 inch stainless steel plates. Each stainless steel plate contained a 4 inch diameter hole in the center. Each nonwoven sample was submitted to the fire test conditions as outlined in the California Technical Bulletin 603 testing conditions for the top burner. After exposure to the open flame via a specific gas burner, gram weights were place on top of each nonwoven sample until the weights broke the web. The amount of each weight was recorded in grams. The highest and lowest number were discarded and an average of 20 samples each was calculated.

Evaluation of Burst Strength

| | | Sample | Burst |
|---|---|---|---|
| Sample Type | Sample # | Wt. | Wt. |
| Nonwoven Highloft | 1 | 5.7 | 170 |
| Nonwoven Highloft | 2 | 5.8 | 200 |
| Nonwoven Highloft | 3 | 5.7 | 200 |
| Nonwoven Highloft | 4 | 5.6 | 270 |
| Nonwoven Highloft | 5 | 5.7 | 190 |
| Nonwoven Highloft | 6 | 5.6 | 185 |
| Nonwoven Highloft | 7 | 5.7 | 195 |
| Nonwoven Highloft | 8 | 5.8 | 205 |
| Nonwoven Highloft | 9 | 5.7 | 200 |
| Nonwoven Highloft | 10 | 5.7 | 190 |
| Nonwoven Highloft | 11 | 5.8 | 205 |
| Nonwoven Highloft | 12 | 5.6 | 180 |
| Nonwoven Highloft | 13 | 5.7 | 200 |
| Nonwoven Highloft | 14 | 5.7 | 195 |
| Nonwoven Highloft | 15 | 5.8 | 210 |
| Nonwoven Highloft | 16 | 5.8 | 205 |
| Nonwoven Highloft | 17 | 5.7 | 190 |
| Nonwoven Highloft | 18 | 5.6 | 180 |
| Nonwoven Highloft | 19 | 5.7 | 190 |
| Nonwoven Highloft | 20 | 5.7 | 195 |
| Nonwoven Highloft | 21 | 5.8 | 205 |
| Nonwoven Highloft | 22 | 5.7 | 190 |
| Average | | 5.72 | 196 |

| | | Sample | Burst |
|---|---|---|---|
| Sample Type | Sample # | Wt. | Wt. |
| Nonwoven | 1 | 5.7 | 95 crack in center |
| Calendared | | | |
| NW Calendared | 2 | 5.8 | 235 |
| NW Calendared | 3 | 5.7 | 230 |
| NW Calendared | 4 | 5.6 | 210 |
| NW Calendared | 5 | 5.7 | 230 |
| NW Calendared | 6 | 5.6 | 205 |
| NW Calendared | 7 | 5.7 | 230 |
| NW Calendared | 8 | 5.8 | 240 |
| NW Calendared | 9 | 5.7 | 235 |
| NW Calendared | 10 | 5.7 | 235 |
| NW Calendared | 11 | 5.8 | 245 |
| NW Calendared | 12 | 5.6 | 210 |
| NW Calendared | 13 | 5.7 | 225 |
| NW Calendared | 14 | 5.7 | 230 |
| NW Calendared | 15 | 5.8 | 270 |
| NW Calendared | 16 | 5.8 | 230 |
| NW Calendared | 17 | 5.7 | 225 |
| NW Calendared | 18 | 5.6 | 200 |
| NW Calendared | 19 | 5.7 | 230 |
| NW Calendared | 20 | 5.7 | 220 |
| NW Calendared | 21 | 5.8 | 235 |
| NW Calendared | 22 | 5.7 | 230 |
| Average | | 5.72 | 226 |

226 − 196/226 × 100 = 13.3% increase

The nonwoven calendared fabric constructed in accordance with the invention forms a reinforced char barrier that is at least 13.3% stronger than a charred nonwoven highloft fabric.

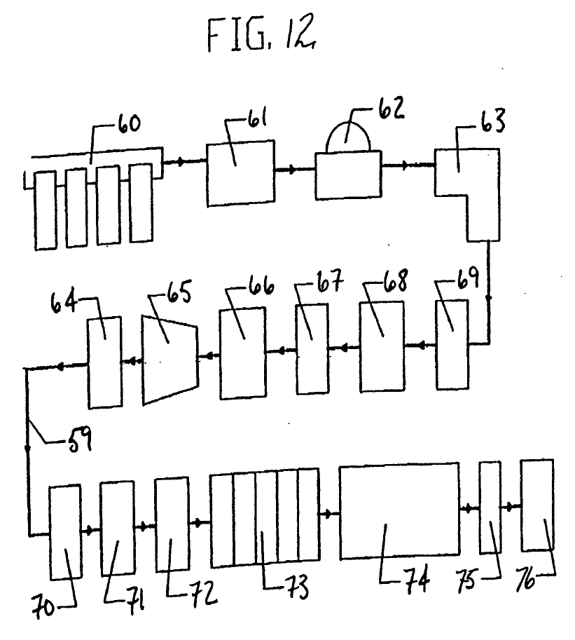

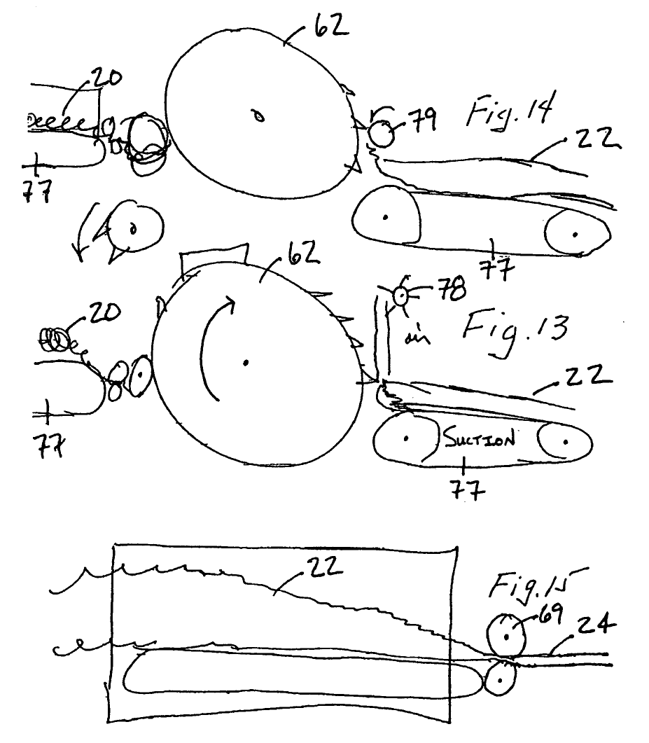

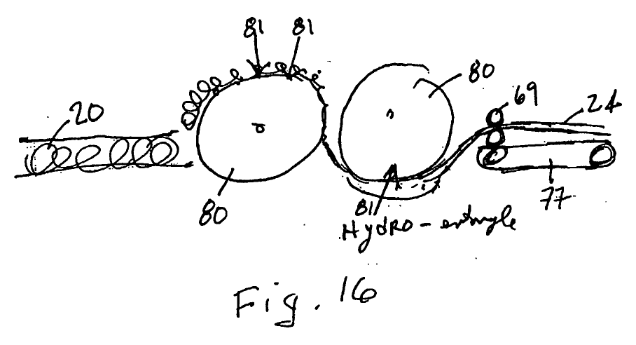

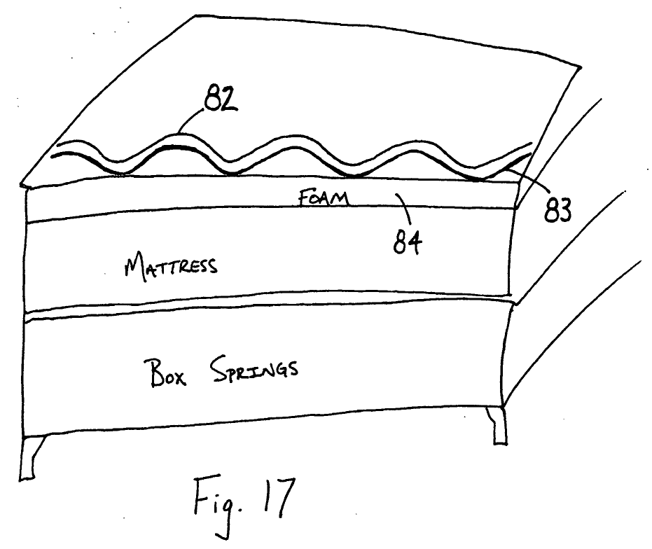

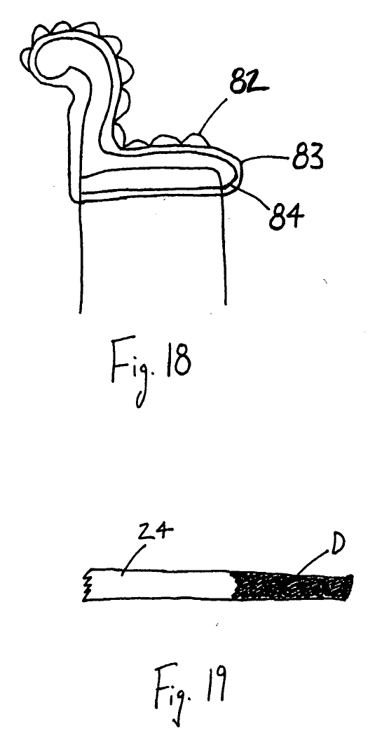

FIG. 12 illustrates a preferred method of manufacturing a needle-punched non-woven flame blocking fabric capable of forming a reinforced char barrier upon exposure to flame which prevents the flame from igniting any flammable substrate in accordance with the invention. The line direction is illustrated at 59. Fiber opening hopper and fiber conveyor 60 are needling machine components whereby the individual concentrations of fibers are fed into the line. The fibers are opened and broken apart from bales into smaller portions and are intimately blended in the hopper. After the fibers have been processed in the opening hoppers they are conveyed to the fiber reserve opener 61. The fiber reserve opener, in addition to continuing to open and blend the fiber concentrations, acts as a reservoir to house a sufficient amount of fibers to supply the downstream line demand without interruption of the line. Carding machine 62 completes the fiber disentangling process while simultaneously creating a continuous fibrous web with a minimum amount of weight deviation. Crosslapper 63 receives the continuous fiber web from the carding machine 62. Utilizing a “back” and “forward” traversing motion the crosslapper forms a layered web of fiber onto a moving conveyer.

The resultant thick layered fibrous web is then conveyed into the throat or entry rolls of a web drafter 64. The web drafter consists of a series of rolls positioned one above the other. The upper set of rolls can be adjusted to form an “adjustable gap” to vary the pressure exerted by the rolls on the web passing through the drafter. Typically, the drafter rolls are clustered in groups of three, with each cluster as well as each roll, having an independent speed adjustment so that as the fibrous web passes through the drafter, the web is drafted down to a thinner web. Changes in fiber direction may also be made by the drafter. Prior to reaching pre-needle loom 65, the fibrous web has virtually no tensile strength due to the fact that the process up to this point has consisted of merely laying the fiber concentrations onto a machine component without any bonding or mechanical fiber entanglement. Pre-needle loom 65 consists of thousands of barbed needles, which through an up and down motion penetrates the fibrous web, the barbed needles carrying the fibers from one side of the web to the other. The fibers are thus interlocked, imparting strength to the fibrous web. Stretch machine 66 receives the needle-punched fibrous web from the pre-needle-loom 65. The stretch machine consists of a series of rolls revolving at successively increasing speeds to stretch and further tighten the interlocking of the fibers. Finish loom 67 is identical to pre-needle loom 65.

Tenter frame 68 grasps the edges of the needle-punched fabric and stretches the fabric crosswise, widening the fabric. Calendar roll 69 consists of two or more rolls which may be heated. When brought into contact with the each other the rolls can apply various amounts of pressure and or heat to the fabric. Typically, when the fabric is subjected to calendar pressure and heat the fabric becomes thinner, having a low profile, and gains significant strength. A scray 70 allows various amounts of fabric to accumulate when the winder must be stopped for roll changes. More importantly, the fabric accumulation managed by the scray allows the line to continue operation without interruption. Position 71 is a dip tank with squeeze rolls. The dip tank typically contains various liquids, such as a flame retardant, to be applied to the fabric. The dip tank allows the fabric to be completely saturated by the liquid. The dip tank has a series of rollers, some positioned beneath the liquid surface, some positioned above, through which the fabric is successively routed in and out of the liquid to saturate the fabric. The squeeze rolls squeeze excess liquid from the saturated fabric.

Position 72 is a foam applicator which can alternative to, or in addition to dip and squeeze tank 71, apply a foam of various chemicals or compounds such as a flame retardant to the fabric. The fabric passing through the dip and squeeze tank and or the foam applicators is wet. Steam filled drying cans 73 dries the fabric by driving out or boiling off excess moisture on the fabric. Depending upon the chemical or compound applied to the fabric the steam cans may also cause the application to heat set and cure. In order to achieve adequate drying at faster line speeds and or to penetrate very thick fabrics, hot air oven 74 can provide this function to the process. Fabric exiting the steam cans 73 or hot air ovens 74 is typically very hot, and needs to be cooled before winding.

Cooling cans 75 bring the fabric temperature down to a temperature suitable for winding. Depending on the size of the fabric desired, slitter/winder 76 has blades which may be employed to cut the fabric in the machine direction into a desired width.

While a preferred embodiment of the invention has been described using specific terms, such description is for illustrative purposes only, and it is to be understood that changes and variations may be made to the a non-woven flame blocker fabric constructed in accordance with the invention that will not ignite or burn upon exposure to open flame and the resultant heat but instead forms a reinforced char barrier that prevents a flame from igniting any flammable substrate, its parts, and methods of manufacture, without departing from the spirit or scope of the following claims.

What is claimed is:

1. A method for manufacturing a non-woven flame blocking fabric, comprising the steps of:
blending a concentration of natural fibers selected from the group consisting of vissil, cotton, hemp, kenauf, rayon, tencel, flax and wool capable of charring upon exposure to flame to form a char component, a concentration of synthetic fibers selected from the group consisting of polyester, polypropylene, polyamide and polyethylene capable of melting upon exposure to flame to form a reinforcement component to provide structural integrity to the char component, and a concentration of binder fiber or powder serving as a bonding agent to form an unbonded fiber blend;
bonding the fiber concentrations to form a bonded fiber blend;
applying a flame retardant; and
compressing the bonded fiber blend into a low profile calendar sheet of non-woven flame blocking fabric with at least one pair of calendar rolls.

2. The method of claim 1, wherein the concentration of binder fiber or powder is pre-treated with the flame retardant.

3. The method of claim 1, wherein the calendar rolls are heated.

4. The method of claim 1, wherein the fiber concentrations are pre-treated with flame retardant.

5. The method of claim 1, wherein the unbonded fiber blend is treated with the flame retardant.

6. The method of claim 1, wherein the flame retardant is applied to the bonded fibrous web.

7. The method of claim 1, wherein the flame retardant is applied to at least one calendared fabric surface.

8. The method of claim 1, wherein the nonwoven calendared fabric forms a reinforced char barrier that is stronger than a charred nonwoven highloft fabric.

9. A method for manufacturing a fiber blend for use in a flame blocker thermal barrier anti-skid fabric, comprising the steps of:
blending a concentration of organic fibers selected from the group consisting of vissil, cotton, hemp, kenauf, rayon, tencel, flax and wool capable of charring upon exposure to flame to form a char component, a concentration of inorganic fibers selected from the group consisting of polyester, polypropylene, polyamide and polyethylene capable of melting upon exposure to flame to form a reinforcement component to provide structural integrity to the char component, and a concentration of binder fiber or powder serving as a bonding agent to form an unbonded fiber blend;
and applying a flame retardant to the unbonded fiber blend.
